(19) United States
(12) Patent Application Publication
(10) Pub. No.: US 2010/0141010 A1
(43) Pub. Date: Jun. 10, 2010

(54) Device for a Seat Belt Guide

(76) Inventor: Hanne Lahnstein Hamsund, Oslo (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/530,324

(22) PCT Filed: Mar. 6, 2008
(86) PCT No.: PCT/NO08/00083

§ 371 Date: Jan. 22, 2010

(30) Foreign Application Priority Data
Mar. 8, 2007 (NO) 20071280

(51) Int. Cl. B60R 22/30; B60R 22/00

(52) U.S. Cl. 297/468

(57) ABSTRACT

A device for a seat belt guide having a first connector portion fitting in a complementary manner with a stationary seat belt connector, and having a second connector portion fitting in a complementary and releasable manner with a free connector of a seat belt when in a released position, wherein the seat belt guide is provided with a stabilizing body arranged to bear against a seat cushion or an adjoining component.

This invention concerns a seat belt guide. More particularly, it concerns a seat belt guide having a first connector portion fitting in a complementary manner with a stationary seat belt connector, and having a second connector portion fitting in a complementary and releasable manner with a free connector of a seat belt when in a released position. The seat belt guide is provided with a stabilizing body bearing against, or being squeezed against, the seat cushion or an adjoining component, the stabilizing body being arranged to be able to keep the seat belt guide in a particular position relative to the seat cushion.

A seat belt, as known from e.g. vehicles, oftentimes comprise a substantially stationary connector frequently positioned near the transition between a seat cushion and a back rest of a seat.

Oftentimes the stationary connector is suspended in a relatively short belt part. It may also be fixedly connected, for example to a seat or a vehicle body part.

When in a released position, the seat belt's free end portion, which normally comprises a belt buckle fitting in a complementary manner with the stationary connector, connects one or several seat belt straps in a releasable manner to the stationary connector when in its operational position.

Particularly when using utility equipment, such as e.g. a child seat, challenges may arise with respect to connecting the belt buckle to the fixed connector located in the transition between the seat cushion and the back rest.

It is known to use a so-called belt extension in order to move the connection point for the belt buckle away from the transition between the seat cushion and the back rest. WO-document 2006/129297 thus concerns a seat belt extension, which is also adjustable lengthwise.

However, use of two hands is also required when the belt buckle is to be connected to a known seat belt extension.

The object of the invention is to remedy or reduce at least one of the disadvantages of the prior art.

The object is achieved according to the invention by virtue of those features disclosed in the following description and in the subsequent claims.

In accordance with the invention, a seat belt guide having a first connector portion fitting in a complementary manner with a stationary seat belt connector, and having a second connector portion fitting in a complementary and releasable manner with a free connector of a seat belt when in a released position, is characterized in that the seat belt guide is provided with a stabilizing body arranged so as to be able to bear against, or to be squeezed against, a seat cushion or an adjoining component.

Advantageously, the first connector portion is pivotal, relative to the stabilizing body, about a first axis being substantially horizontal when in position of use, thereby allowing it to be aligned with respect to the stationary connector.

Likewise, the second connector portion is typically pivotal, relative to the stabilizing body, about a second axis being substantially horizontal when in position of use. Advantageously, the second connector portion is pivotally adjustable about the second axis. Thereby, the second connector portion may be set at a suitable angle relative to the stabilizing body. The second connector portion may be adjustable lengthwise.

In a practical embodiment, the first axis and the second axis oftentimes coincide.

Advantageously, the stabilizing body is pivotal about a third axis being approximately horizontal when in position of use, typically being near perpendicular relative to the first and the second axis. Thereby, it is possible to align the stabilizing body relative to the seat cushion and a potential adjoining piece of utility equipment.

The stabilizing body may form a part of the adjoining piece of utility equipment, such as e.g. a child seat.

A seat belt guide according to the invention allows for one-hand connection of the free connector to the corresponding second connector portion, insofar as the seat belt guide is kept in a relatively stable position near the seat cushion by means of the stabilizing body.

Hereinafter, an example of a preferred embodiment is described, the embodiment of which is depicted in the accompanying drawings, where:

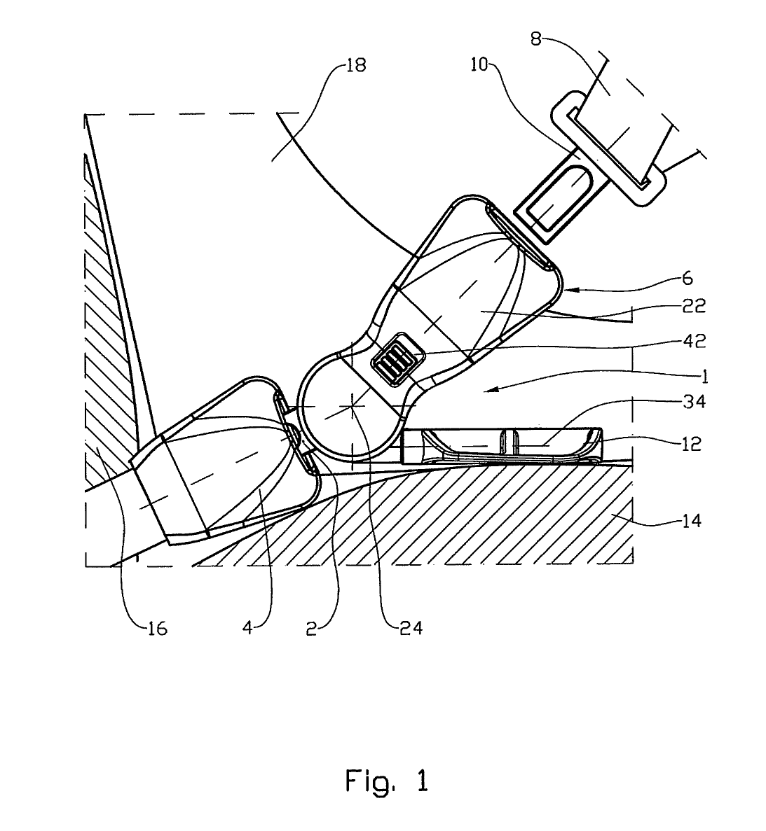

FIG. 1 shows a side view of a seat belt guide according to the invention connected to a stationary seat belt connector;

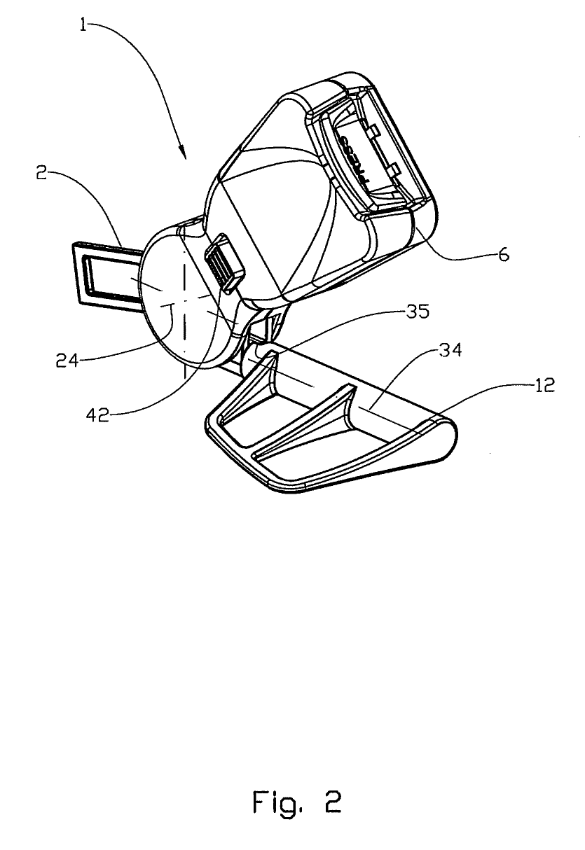

FIG. 2 shows a perspective view of the seat belt guide; and

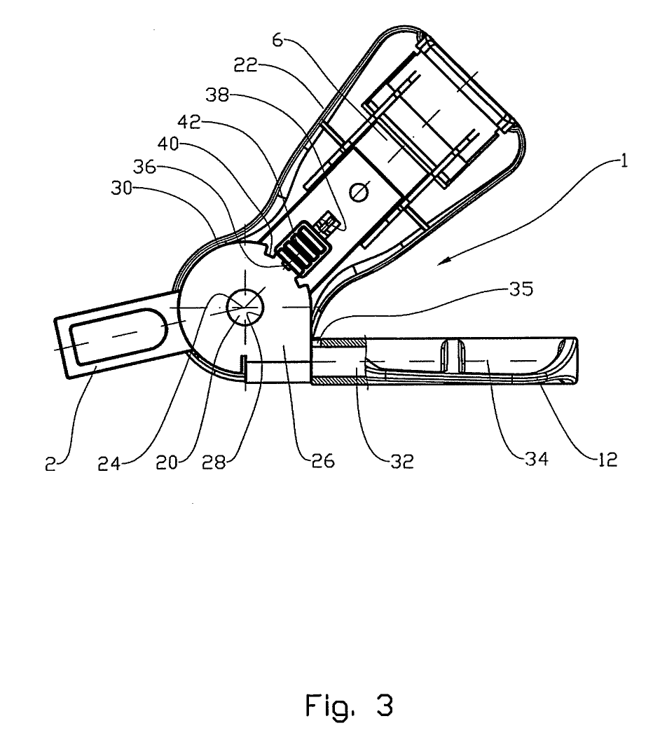

FIG. 3 shows a side view, in partial cross-section, of the seat belt guide having a cover removed.

In the drawings, reference numeral 1 denotes a seat belt guide comprising a first connector portion 2 fitting in a complementary manner into a stationary seat belt connector 4, and a second connector portion 6 fitting in a complementary manner with a free connector 10 of a seat belt 8 when in a released position.

A stabilizing body 12 is arranged to bear against a seat cushion 14.

In FIG. 1 the stationary seat belt connector 4 is shown in the area between the seat cushion 14 and a back rest 16. A child seat 18 is placed beside the seat belt guide 1 and on the seat cushion 14.

The first connector portion 2, the second connector portion 6, and the stabilizing body 12 are connected together by means of a shaft 20, see FIG. 3. In FIG. 3 a part of a cover 22 has been removed.

The centre axis 24 of the shaft 20 coincides with the first axis and the second axis mentioned in the general part of the description. A shaft holder 26, which is comprised of a U-shaped plate portion, is provided with bores 28 fitting with the shaft 20. The free edges 30 of the shaft holder 26 are of a generally circular shape being coaxial with the bores 28.

The shaft holder 26 is fixedly connected to a spindle 32, the centre axis 34 of the spindle 32 forming the third axis described in the general part. The centre axis 34 is perpendicular to the centre axis 24 of the shaft 20.

The stabilizing body 12 is pivotally connected to the spindle 32, but is prevented from being able to pivot freely by virtue of it impinging on a stop dog 35 in the shaft holder 26.

Both the first connector portion 2 and the second connector portion 6 are pivotally connected to the shaft 20.

Corresponding to a latch slide 36 movable in a track 38 in the second connector portion 6, the side edges 30 of the shaft holder 26 are provided with a number of latch grooves 40. The latch slide 36 is biased against the shaft holder 26 by means of a spring (not shown). When the latch slide 36 is located in one of the latch grooves 40, the second connector portion 6 is prevented from being able to pivot about the shaft 20.

A release button 42 is connected to the latch slide 36. By moving the release button 42 in a direction away from the shaft 20, the latch slide 36 is moved out of the latch groove 40, whereby the second connector portion 6 may be pivoted to a desired angle relative to the stabilizing body 12. Upon letting go of the release button 42, the latch slide 36 will seek to move down into the first latch groove 40 encountered.

Moreover, the first connector portion 2 and the second connector portion 6 are formed in accordance with prior art per se and is therefore not described further.

When the seat belt guide 1 is to be used, the first connector portion 2 is moved into and is locked to the stationary seat belt connector 4, whereupon the stabilizing body 12 is put against the seat cushion 14. The first connector portion 2 will thus be pivoted about the shaft 20 until the first connector portion 2 assumes a suitable angle relative to the stabilizing body 12.

By moving the release button 42 in a releasing direction, the second connector portion 6 may be pivoted about the shaft 20 to a desired angle facilitating the insertion of the free connector 10.

In an alternative embodiment not shown, the spindle is given an angular shape, for example square-shaped, so as to be able to move the stabilizing body 12 along the spindle 32 in around various, fixed positions, insofar as the stabilizing body is formed so as to fit onto the angular spindle 32.

1. A device for a seat belt guide comprising a first connector portion fitting in a complementary manner with a stationary seat belt connector, and having a second connector portion fitting in a complementary and releasable manner with a free connector of a seat belt when in a released position, wherein the seat belt guide is provided with a stabilizing body arranged to bear against a seat cushion or an adjoining component.

2. The device according to claim 1, wherein the first connector portion is pivotal, relative to the stabilizing body, about a first axis being substantially horizontal when in position of use.

3. The device according to claim 1, wherein the second connector portion is pivotal, relative to the stabilizing body, about a second axis being substantially horizontal when in position of use.

4. The device according to claim 3, wherein the second connector portion is pivotally adjustable about the second axis.

5. The device according to claims 2, wherein the first axis and the second axis coincide.

6. The device according to claim 1, wherein the stabilizing body is pivotal about a third axis being horizontal when in position of use.

7. The device according to claim 1, wherein the stabilizing body forms a part of a piece of utility equipment, such as a child seat.

8. The device according to claim 3, wherein the first axis and the second axis coincide.
